(19) United States
(12) Patent Application Publication
(10) Pub. No.: US 2023/0251687 A1
(43) Pub. Date: Aug. 10, 2023

(54) FOLDABLE ELECTRONIC DEVICE COMPRISING FLEXIBLE CABLE

(71) Applicant: Samsung Electronics Co., Ltd., Suwon-si (KR)

(72) Inventors: Seungchul BAEK, Suwon-sI (KR); Hyunggeun LEE, Suwon-sI (KR)

(21) Appl. No.: 18/145,274

(22) Filed: Dec. 22, 2022

Related U.S. Application Data
(63) Continuation of application No. PCT/KR2022/018875, filed on Nov. 25, 2022.

(30) Foreign Application Priority Data
Feb. 4, 2022 (KR) 10-2022-0014943
Mar. 14, 2022 (KR) 10-2022-0031505

(51) Int. Cl. G06F 1/16

(52) U.S. Cl. CPC G06F 1/1616; G06F 1/1681; G06F 1/1652

(57) ABSTRACT

A foldable electronic device including a flexible cable is provided. The foldable electronic device includes a foldable enclosure including a plurality of sub-enclosures, wherein the foldable enclosure has an opening opened in a first direction in the unfolded state, a hinge configured to couple the plurality of sub-enclosures to be rotatable, a hinge enclosure configured to cover the hinge from at least a second direction opposite to the first direction and including an inner space, a protrusion protruding on an inner surface of an inner space of the hinge enclosure, and a flexible cable configured to interconnect a plurality of electrical components disposed in the plurality of sub-enclosures while passing through a space between the hinge and the hinge enclosure, wherein, when the foldable enclosure is unfolded, the flexible cable is bent in an area corresponding to the protrusion to protrude in a direction in which the protrusion protrudes.

### CROSS-REFERENCE TO RELATED APPLICATION(S)

This application is a continuation application, claiming priority under § 365(c), of an International application No. PCT/KR2022/018875, filed on Nov. 25, 2022, which is based on and claims the benefit of a Korean patent application number 10-2022-0014943, filed on Feb. 4, 2022, in the Korean Intellectual Property Office, and of a Korean patent application number 10-2022-0031505, filed on Mar. 14, 2022, in the Korean Intellectual Property Office, the disclosure of each of which is incorporated by reference herein in its entirety.

### TECHNICAL FIELD

The disclosure relates to a foldable electronic device. More particularly, the disclosure relates to a flexible cable and a foldable electronic device including the same.

### BACKGROUND ART

Electronic devices require a small profile for portability and require a large display area to provide much information to a user. In order to make a small profile compatible with a large display area in an electronic device, various form factors as in a foldable electronic device equipped with a flexible display are being used in addition to the existing rectangular bar-shaped form factor. An electronic device having a foldable form factor may include a foldable enclosure configured to be folded or unfolded around at least one hinge to fold or unfold a flexible display. The foldable electronic enclosure may have a plurality of sub-enclosures coupled to each other to be rotatable around a hinge.

The foldable electronic device may include a flexible cable. The flexible cable may electrically interconnect electrical components of the foldable electronic device disposed in each of a plurality of sub-enclosures of the foldable housing, such as a battery, a circuit board, and a camera, to transmit power and information. The flexible cable may pass through a hinge to connect one electrical component inside one sub-enclosure to another electrical component disposed in another sub-enclosure. Since the flexible cable is bendable, when the foldable enclosure is folded and unfolded around the hinge, the flexible cable is bent while maintaining electrical conductivity, thereby maintaining the electrical connection between the electrical components interconnected by the flexible cable.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

During the folding and unfolding operation of the foldable electronic device, the flexible cable may be damaged due to interference and rubbing between the components inside the foldable enclosures and the flexible cable. In order to avoid the above-mentioned interference, the flexible cable is required to have an appropriate length. In addition, the flexible cable may be limited in length due to the limitation of the space inside a hinge enclosure protecting the hinge. When the length of the flexible cable is long compared to the space inside the hinge enclosure, the flexible cable may be damaged due to excessive folding. When the space inside the hinge enclosure is increased in order to accommodate a flexible cable having an appropriate length, the size of the hinge area is excessively increased, which may make it inconvenient for users to hold and use the foldable electronic device and may increase the thickness of the foldable electronic device.

Aspects of the disclosure are to address at least the above-mentioned problems and/or disadvantages and to provide at least the advantages described below. Accordingly, an aspect of the disclosure is to provide a foldable electronic device in which a risk of damage to a flexible cable is reduced and the size of a hinge portion is reduced.

Additional aspects will be set forth in part in the description which follows and, in part, will be apparent from the description, or may be learned by practice of the presented embodiments.

### Solution to Problem

In accordance with an aspect of the disclosure, a foldable electronic device including a plurality of electrical components is provided. The foldable electronic device includes a foldable enclosure including a plurality of sub-enclosures in each of which at least one electrical component is located, wherein the foldable enclosure is configured to be folded and unfolded and has an opening opened in a first direction in the unfolded state, a hinge configured to couple the plurality of sub-enclosures to be rotatable around at least one rotational axis, a hinge enclosure configured to cover the hinge from at least a second direction opposite to the first direction and including an inner space, a protrusion protruding on an inner surface of an inner space of the hinge enclosure, and a flexible cable configured to interconnect a plurality of electrical components disposed in the plurality of sub-enclosures while passing through a space between the hinge and the hinge enclosure, wherein, when the foldable enclosure is unfolded, the flexible cable is bent in an area corresponding to the protrusion to protrude in a direction in which the protrusion protrudes.

The flexible cable may be plastically formed such that the area corresponding to the protrusion protrudes in the direction in which the protrusion protrudes. The protrusion may restrict the flexible cable from being bent asymmetrically around the protrusion by being engaged with the plastically formed area of the flexible cable.

The inner space may be provided in an area through which the flexible cable passes. In some embodiments, the protrusion may be located on a center line of the inner space of the hinge enclosure when viewed in the first direction.

The protrusion may extend in the inner space in a direction of the rotation axis of the hinge. In some embodiments, the protrusion may protrude in a direction perpendicular to the inner surface of the inner space. In some embodiments, the protrusion may reinforce the hinge enclosure by extending in the direction perpendicular to the inner surface of the inner space.

The hinge enclosure may include a plurality of protrusions protruding on the inner surface of the inner space. In some embodiments, the flexible cable may be plastically formed such that a plurality of areas corresponding to the plurality of protrusions are bent in a direction in which the protrusions protrude. In some embodiments, the plurality of protrusions may be located adjacent to each other in one area on the inner surface of the inner space, and the flexible cable may be plastically formed such that the flexible cable is bent in an area corresponding to an area in which the plurality of protrusions located adjacent to each other are plastically formed in the direction in which the protrusions protrude. In some embodiments, the hinge enclosure may include a reinforcing member located between the plurality of protrusions on the inner surface of the inner space and connecting the plurality of protrusions to each other.

The electronic device may include a buffer member disposed on the surface of each of the protrusions. In some embodiments, the electronic device may include a lubricating member disposed on the surface of each of the protrusions.

In accordance with another aspect of the disclosure, a flexible cable of a foldable electronic device is provided. The flexible cable for a foldable electronic device includes a plurality of electrical components, a foldable enclosure including a plurality of sub-enclosures in each of which at least one of the plurality of electrical components is disposed, wherein the foldable enclosure is configured to be folded and unfolded and has an opening opened in a first direction in an unfolded state, a hinge configured to couple the plurality of sub-enclosures to be rotatable around at least one rotational axis, and a hinge enclosure configured to cover the hinge from at least a second direction opposite to the first direction and including an inner space, and a flexible cable, wherein the flexible cable may be configured to interconnect a plurality of electrical components disposed in the plurality of sub-enclosures while passing through a space between the hinge and the hinge enclosure, and wherein, when the foldable enclosure is unfolded, the flexible cable is bent in an area corresponding to the protrusion to protrude in the first direction.

The flexible cable may be plastically formed such that the area corresponding to the protrusion protrudes in the direction in which the protrusion protrudes.

In accordance with another aspect of the disclosure, a hinge enclosure of a foldable electronic device is provided. The hinge enclosure includes a plurality of electrical components, a foldable enclosure including a plurality of sub-enclosures in each of which at least one of the plurality of electrical component is disposed, wherein the foldable enclosure is configured to be folded and unfolded and has an opening opened in a first direction in an unfolded state, a hinge configured to couple the plurality of sub-enclosures to be rotatable around at least one rotational axis, a hinge enclosure configured to at least partially cover the hinge, and a flexible cable configured to electrically interconnect at least two of the plurality of electrical components disposed in the plurality of sub-enclosures while passing through the hinge enclosure, wherein the hinge enclosure includes a plurality of protrusions protruding on the inner surface of the inner space.

The hinge enclosure may include a plurality of protrusions protruding on the inner surface of the inner space thereof.

In accordance with another aspect of the disclosure, a foldable electronic device is provided. The foldable electronic device includes a foldable enclosure including a plurality of sub-enclosures in each of which at least one electrical component is located, wherein the foldable enclosure is configured to be folded and unfolded and has an opening opened in a first direction in an unfolded state, a hinge configured to couple the plurality of sub-enclosures to be rotatable around at least one rotational axis, a hinge enclosure configured to cover the hinge from at least a second direction opposite to the first direction and including an inner space, and a flexible cable configured to interconnect a plurality of electrical components disposed in the plurality of sub-enclosures while passing through a space between the hinge and the hinge enclosure, wherein, when the foldable enclosure is unfolded, the flexible cable is bent in an area corresponding to the protrusion to protrude in the first direction.

### Advantageous Effects of Invention

According to various embodiments disclosed herein, it is possible to provide a foldable electronic device in which since the flexible cable is bent in the inner space of the hinge enclosure, the risk of damage to the flexible cable may be reduced, and the hinge portion may have a reduced size.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a view illustrating an electronic device in the unfolded state according to an embodiment of the disclosure;

FIG. 2B is a view illustrating the electronic device of FIG. 1A in the folded state according to an embodiment of the disclosure;

FIG. 2C is an exploded perspective view of an electronic device according to an embodiment of the disclosure;

FIG. 3A is an exploded perspective view of a foldable electronic device in the unfolded state according to an embodiment of the disclosure;

FIG. 3B is a front view of the foldable electronic device in the unfolded state according to an embodiment of the disclosure;

FIG. 4A is a perspective view illustrating a flexible cable according to an embodiment of the disclosure;

FIG. 4B is a side view illustrating the flexible cable according to an embodiment of the disclosure;

FIG. 5A is a plan view illustrating a hinge enclosure of a foldable electronic device according to an embodiment of the disclosure;

FIG. 5B is a cross-sectional view illustrating the hinge enclosure of the foldable electronic device according to an embodiment of the disclosure;

FIG. 6A is a cross-sectional view of a hinge portion of a foldable electronic device in the unfolded state according to an embodiment of the disclosure;

FIG. 6B is a cross-sectional view of the hinge portion of the foldable electronic device in the folded state according to an embodiment of the disclosure;

FIG. 7A is a cross-sectional view of a hinge portion of a foldable electronic device in the folded state according to an embodiment of the disclosure;

FIG. 7B is a cross-sectional view of a hinge portion of a foldable electronic device according to an embodiment of the disclosure;

FIG. 7C illustrates enlarged cross-sectional views of the hinge portions of the foldable electronic devices according to an embodiment of the disclosure;

FIG. 7D is a schematic view illustrating a hinge enclosure and a flexible cable of a foldable electronic device of a comparative example according to an embodiment of the disclosure;

FIG. 8A is a schematic view illustrating a hinge enclosure and a flexible cable of a foldable electronic device according to an embodiment of the disclosure;

FIG. 8B is a schematic view illustrating a hinge enclosure and a flexible cable of a foldable electronic device according to an embodiment of the disclosure;

FIG. 9A is a schematic view illustrating a hinge enclosure and a flexible cable of according to an embodiment of the disclosure;

FIG. 9B is a schematic view illustrating a hinge enclosure and a flexible cable of according to an embodiment of the disclosure; and

FIG. 9C is a schematic view illustrating a hinge enclosure according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

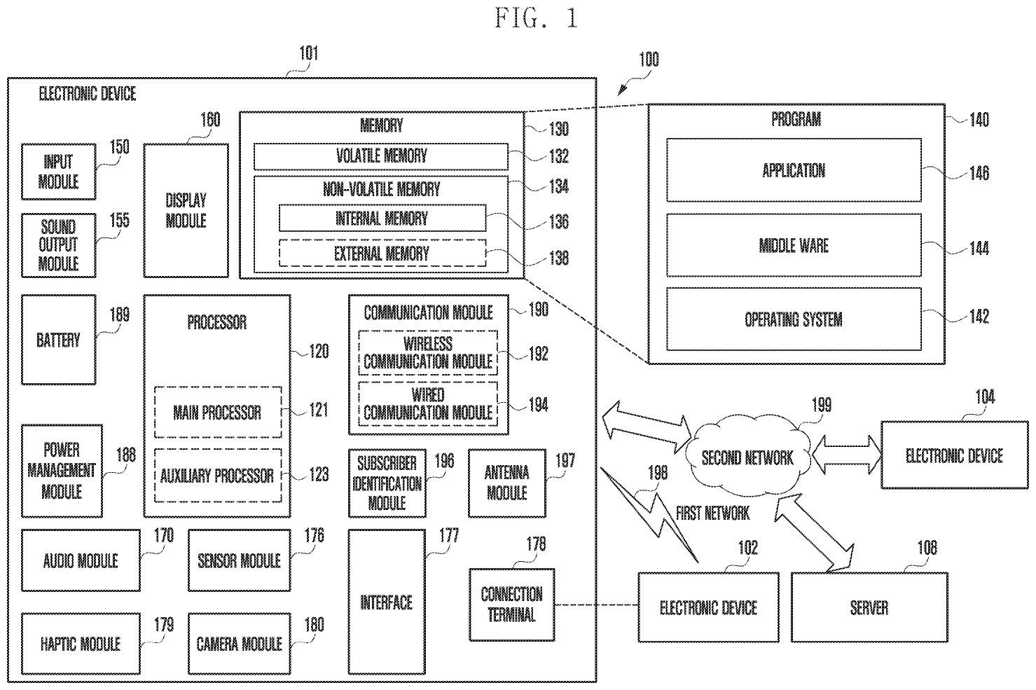

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input 1module 150, a sound output 1module 155, a display 1module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the 11connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). 11

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display 1module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input 1module 150 may receive a command or data to be used by another component (e.g., the processor 120) of the electronic device 101, from the outside (e.g., a user) of the electronic device 101. The input 1module 150 may include, for example, a microphone, a mouse, a keyboard, a key (e.g., a button), or a digital pen (e.g., a stylus pen).

The sound output 1module 155 may output sound signals to the outside of the electronic device 101. The sound output 1module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display 1module 160 may visually provide information to the outside (e.g., a user) of the electronic device 101. The display 1module 160 may include, for example, a display, a hologram device, or a projector and control circuitry to control a corresponding one of the display, hologram device, and projector. According to an embodiment, the display 1module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input 1module 150, or output the sound via the sound output 1module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of lms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments of the disclosure, a portable electronic device (e.g., the electronic device 101 in FIG. 1) may have a foldable housing divided into two housings about a folding axis. A first portion of a display (e.g., a flexible display) may be disposed on a first housing, and a second portion of the display may be disposed on a second housing. The foldable housing may be implemented as an in-folding type in which the first portion and the second portion face each other when the portable electronic device is folded. Alternatively, the foldable housing may be implemented as an out-folding type in which the first portion and the second portion face away from each other when the portable electronic device is folded. The surface on which the first and second portions of the display are disposed may be defined as a front surface of the portable electronic device, the opposite surface may be defined as a rear surface of the portable electronic device, and the surface surrounding the space between the front and rear surfaces may be defined as the side surface of the portable electronic device.

According to an embodiment disclosed herein, an in-folding case in which, when the display of the portable electronic device is folded, the first portion of the display is disposed on the first housing to face the second portion of the display on the second housing, is illustrated and described by way of an example, but the disclosure is equally applicable to an out-folding case in which, when the display is folded according to an embodiment, the first portion of the display is disposed on the first housing 210 to face away from the second portion of the display on the second housing. In addition, embodiments may be applied to a multi-foldable electronic device in which in-folding and in-folding are combined, in-folding and out-folding are combined, or out-folding and out-folding are combined.

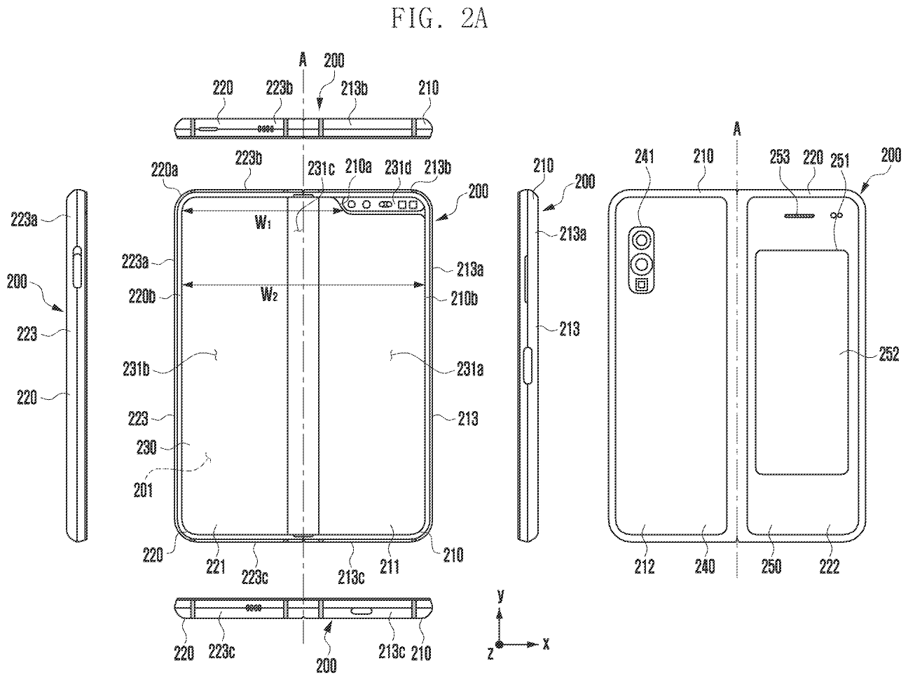

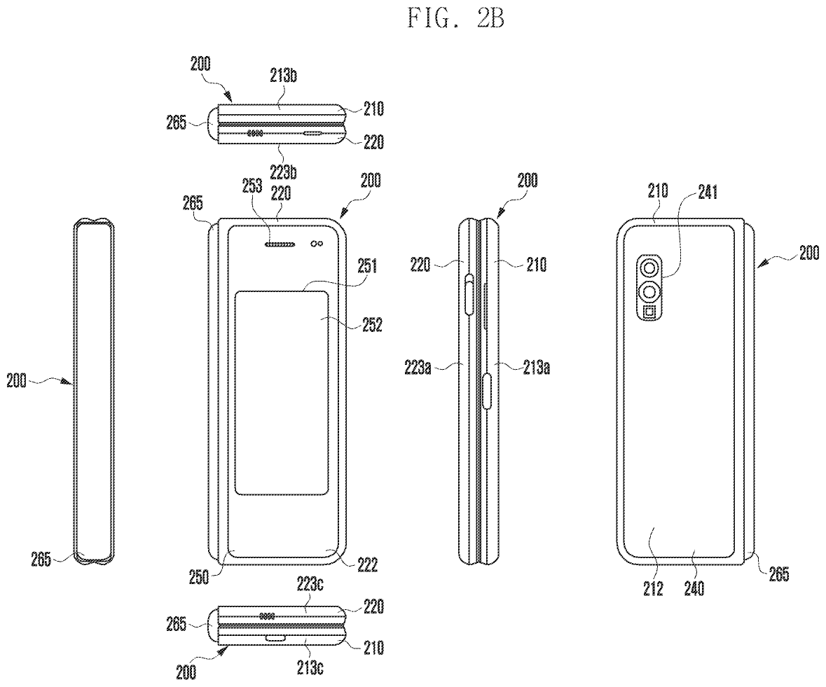

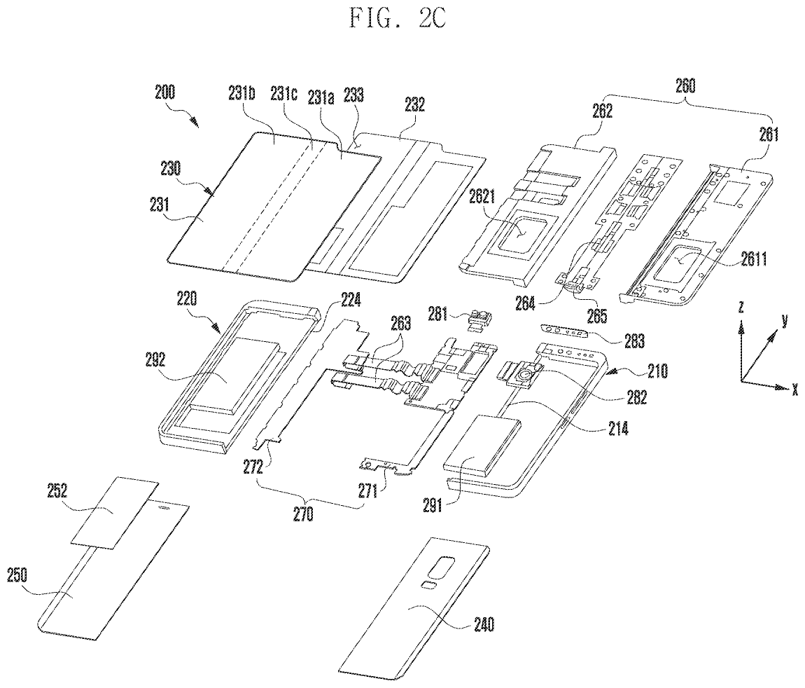

FIG. 2A is a view illustrating an electronic device 200 in the unfolded state according to an embodiment of the disclosure. FIG. 2B is a view illustrating the electronic device 200 of FIG. 2A in the folded state according to an embodiment of the disclosure.

Referring to FIG. 2A, the electronic device 200 may include: a pair of housings 210 and 220 (e.g., a foldable housing structure) pivotably coupled to each other via a hinge structure (e.g., the hinge structure 264 in FIG. 2C) to be folded relative to each other; a hinge cover (e.g., the hinge cover 265 in FIG. 2B) configured to cover the foldable portions of the pair of housings 210 and 220; and a display 230 (e.g., a flexible display, a foldable display, or a first display) disposed in a space provided by the pair of housings 210 and 220.

The surface on which the display 230 is disposed may be defined as the front surface of the electronic device 200, and the surface opposite the front surface may be defined as the rear surface of the electronic device 200.

The surface surrounding the space between the front surface and the rear surface may be defined as the side surface of the electronic device 200.

The direction in which the front surface is oriented may be defined as a first direction, and the direction in which the rear surface is oriented may be defined as a second direction.

In describing a stacking order (e.g., the stacking order of the display) herein, “a layer B is provided on a layer A” may mean that the layer B is formed in the first direction from the layer A. Alternatively, in describing a stacking order (e.g., the stacking order of the display) herein, “a layer B is provided under a layer A” may mean that the layer B is formed in the second direction from the layer A.

The pair of housings 210 and 220 may include a first housing 210 including a sensor area 231d, a second housing 220, a first rear surface cover 240, and a second rear surface cover 250. The pair of housings 210 and 220 of the electronic device 200 are not limited to the shape and assembly illustrated in FIGS. 2A and 2B, but may be implemented by other shapes or other combinations and/or assemblies of components. For example, in another embodiment, the first housing 210 and the first rear surface cover 240 may be integrally configured, and the second housing 220 and the second rear surface cover 250 may be integrally configured.

The first housing 210 and the second housing 220 may be disposed on opposite sides about a folding axis (axis A), and may have substantially symmetrical shapes with respect to the folding axis (axis A). The first housing 210 and the second housing 220 may form an angle or a distance therebetween, which may be variable depending on whether the electronic device 200 is in an unfolded or flat state, in a folded state, or in an intermediate state. According to an embodiment of the disclosure, the first housing 210 may additionally include a sensor area 231d in which various sensors are disposed, unlike the second housing 220, but the first housing 210 and the second housing 220 may have mutually symmetrical shapes in other areas. In another embodiment, the sensor area 231d may be additionally disposed or replaced in at least a partial area of the second housing 220.

The electronic device 200 may operate in an in-folding type and/or an out-folding type when the first housing 210 is rotated with respect to the second housing 220 in a range from 0 degrees to 360 degrees via a hinge (e.g., the hinge 264 in FIG. 2C). The hinge 264 may be provided in a vertical direction or a horizontal direction when the electronic device 200 is viewed from above. According to an embodiment of the disclosure, a plurality of hinges 264 may be provided. For example, all of the plurality of hinges may be arranged in the same direction. As another example, some hinges among the plurality of hinges may be arranged in different directions and folded.

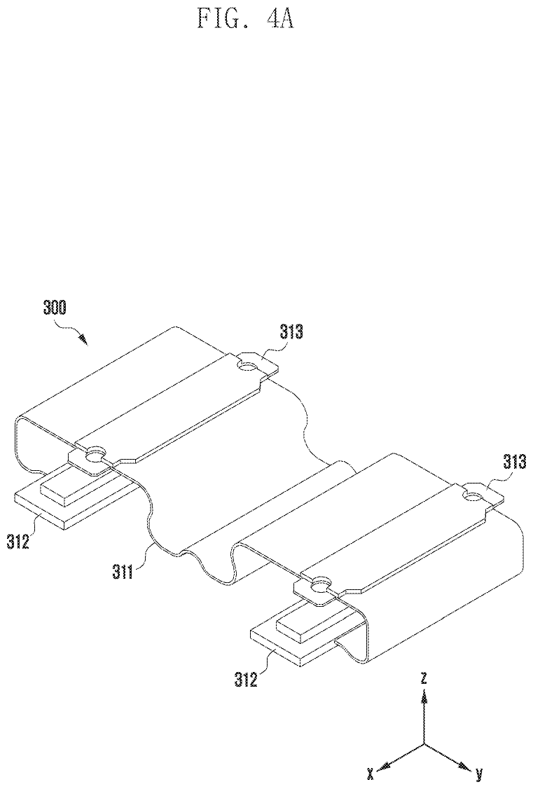

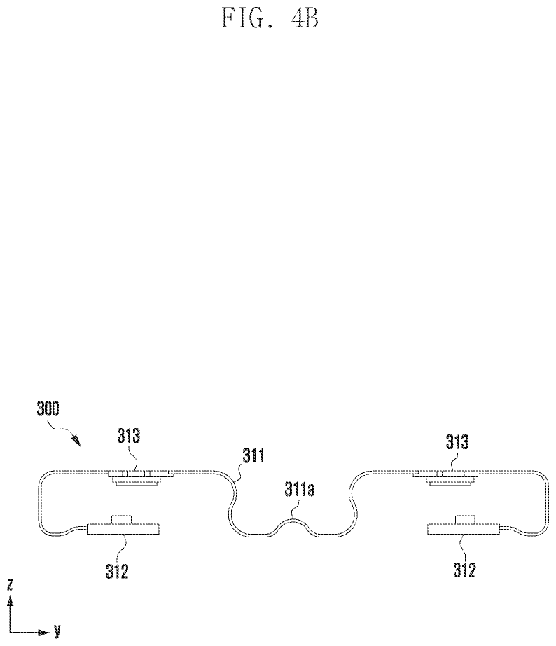

In the unfolded state of the electronic device 200, the first housing 210 may include a first surface 211 connected to a hinge (e.g., the hinge 264 in FIG. 4) and arranged to face the front surface of the electronic device 200, a second surface 212 facing away from the first surface 211, and a first side surface member 213 surrounding at least a portion of the space between the first surface 211 and the second surface 212. The first side surface member 213 may include a first side surface 213a arranged in parallel to the folding axis (the axis A), a second side surface 213b extending from one end of the first side surface 213a in a direction perpendicular to the folding axis (the axis A), and a third side surface 213c extending from the other end of the first side surface 213a in the direction perpendicular to the folding axis (the axis A).

In the unfolded state of the electronic device 200, the second housing 220 may include a third surface 221 connected to a hinge (e.g., the hinge 264 in FIG. 2C) and arranged to face the front surface of the electronic device 200, a fourth surface 222 facing away from the third surface 221, and a second side surface member 223 surrounding at least a portion of the space between the third surface 221 and the fourth surface 222. The second side surface member 223 may include a fourth side surface 223a arranged in parallel to the folding axis (the axis A), a fifth side surface 223b extending from one end of the fourth side surface 223a in the direction perpendicular to the folding axis (the axis A), and a sixth side surface 223c extending from the other end of the fourth side surface 223a in the direction perpendicular to the folding axis (the axis A). In the folded state, the third surface 221 may face the first surface 211.

The electronic device 200 may include a recess 201 provided to accommodate the display 230 through structural shape coupling of the first housing 210 and the second housing 220. The recess 201 may have substantially the same size as the display 230. The recess 201 may have two or more different widths in the direction perpendicular to the folding axis A due to the sensor area 231d. For example, the recess 201 may have a first width W1 between a first portion 220a of the second housing 220, which is parallel to the folding axis A, and a first portion 210a provided at an edge of the sensor area 231d of the first housing 210, and a second width W2 between a second portion 220b of the second housing 210 and a second portion 210b of the first housing 210, which does not correspond to the sensor area 231d and is parallel to the folding axis (the axis A). In this case, the second width W2 may be longer than the first width W1. For example, the recess 201 may have the first width W1 from the first portion 210a of the first housing 210 to the first portion 220a of the second housing 220, which are asymmetric to each other, and the second width W2 from the second portion 210b of the first housing 210 to the second portion 220b of the second housing 220, which are symmetric to each other. The first portion 210a and the second portion 210b of the first housing 210 may have different distances from the folding axis A, respectively. The widths of the recess 201 are not limited to the illustrated example. In an embodiment, the recess 201 may have two or more different widths due to the shape of the sensor area 231d or the asymmetric portions of the first housing 210 and the second housing 220.

The first housing 210 and the second housing 220 may be at least partially formed of a metal material or a non-metal material having the rigidity of a level selected in order to support the display 230.

In the embodiment illustrated in FIG. 2A, the sensor area 231d may have a predetermined area adjacent to one corner of the first housing 210. However, the arrangement, shape, and size of the sensor area 231d is not limited to the illustrated example. For example, according to another embodiment of the disclosure, the sensor area 231d may be provided at another corner of the first housing 210 or in any area between the upper and lower end corners. In another example, the sensor area 231d may be disposed in at least a partial area of the second housing 220. In another example, the sensor area 231d may be disposed to extend over the first housing 210 and the second housing 220. The electronic device 200 may include components configured to perform various functions and arranged to be exposed to the front surface of the electronic device 200 through the sensor area 231d or one or more openings provided in the sensor area 231d. The components may include, for example, at least one of a front camera device, a receiver, a proximity sensor, an illuminance sensor, an iris recognition sensor, an ultrasonic sensor, or an indicator.

The first rear surface cover 240 may be disposed on the second surface 212 of the first housing 210, and may have a substantially rectangular periphery. At least a portion of the periphery may be surrounded by the first housing 210. Similarly, the second rear surface cover 250 may be disposed on the fourth surface 222 of the second housing 220, and at least a portion of the periphery of the second rear surface cover 250 may be at least partially enclosed by the second housing 220.

In the embodiment illustrated in FIG. 2A, the first rear surface cover 240 and the second rear surface cover 250 may have substantially symmetrical shapes with respect to the folding axis (the axis A). According to another embodiment, the first rear surface cover 240 and the second rear surface cover 250 may have various different shapes. In another example, the first rear surface cover 240 may be configured integrally with the first housing 210, and the second rear surface cover 250 may be configured integrally with the second housing 220.

The first rear surface cover 240, the second rear surface cover 250, the first housing 210, and the second housing 220 may provide, through a mutually coupled structure, a space in which various components (e.g., a printed circuit board, an antenna module, a sensor module, or a battery) of the electronic device 200 may be arranged. In an embodiment, one or more components may be disposed or visually exposed on the rear surface of the electronic device 200. For example, one or more components or sensors may be visually exposed through the first rear surface area 241 of the first rear surface cover 240. The sensors may include a proximity sensor, a rear camera, and/or a flash. At least a portion of a sub-display 252 (e.g., a second display) may be visually exposed through a second rear surface area 251 of the second rear surface cover 250. The electronic device 200 may include a speaker module 253, which is arranged through at least a partial area of the second rear surface cover 250.

The display 230 may be disposed on a space provided by the pair of housings 210 and 220. For example, the display 230 may be seated in a recess 201 provided by the pair of housings 210 and 220 and may be disposed to occupy substantially most of the front surface of the electronic device 200. Accordingly, the front surface of the electronic device 200 may include the display 230, as well as a partial area (e.g., an edge area) of the first housing 210 and a partial area (e.g., an edge area) of the second housing 220, which are adjacent to the display 230. The rear surface of the electronic device 200 may include the first rear surface cover 240, an area (e.g., an edge area) of the first housing 210 adjacent to the first rear surface cover 240, the second rear surface cover 250, and an area (e.g., an edge area) of the second housing 220 adjacent to the second rear surface cover 250.

The display 230 may mean a display in which at least a partial area is deformable into a planar surface or a curved surface. The display 230 may include a folding area 231c, a first area 231a disposed on one side of the folding area 231c (e.g., the right area of the folding area 231c), and a second area 231b disposed on the other side of the folding area 231c (e.g., the left area of the folding area 231c). For example, the first area 231a may be disposed in the first surface 211 of the first housing 210, and the second area 231b may be disposed in the third surface 221 of the second housing 220. The area division of the display 230 is exemplary, and the display 230 may be divided into multiple areas (e.g., four or more areas or two areas) depending on the structure or functions thereof. For example, in the embodiment illustrated in FIG. 2A, the areas of the display 230 may be divided by the folding area 231c or the folding axis (the axis A) extending parallel to the Y axis. However, in another embodiment, the areas of the display 230 may be divided based on another folding area (e.g., a folding area parallel to the X axis) or another folding axis (e.g., a folding axis parallel to the X axis). The above-described area division of the display is merely physical division based on the pair of housings 210 and 220 and the hinge (e.g., the hinge 264 in FIG. 2C), and the display 230 may display one full screen substantially through the pair of housings 210 and 220 and the hinge (e.g., the hinge 264 in FIG. 2C). The first area 231a and the second area 231b may have generally symmetrical shapes about the folding area 231c. However, unlike the second area 231b, the first area 231a may include a cut notch area (e.g., the notch area 233 in FIG. 2C), depending on the existence of the sensor area 231d, and may have a shape symmetrical to the second area 231b in the area other than the notch area. In other words, the first area 231a and the second area 231b may include mutually symmetrical portions and mutually asymmetrical portions.

Referring to FIG. 2B, the hinge cover 265 may be disposed between the first housing 210 and the second housing 220 so as to cover internal components (e.g., the hinge structure 264 in FIG. 2C). The hinge cover 265 may be covered by a portion of each of the first housings 210 and the second housing 220 or may be exposed to the outside depending on the operating state of the electronic device 200 (the unfolded state (flat state) or the folded state).

For example, as illustrated in FIG. 2A, when the electronic device 200 is in the unfolded state, the hinge cover 265 may not be exposed by being covered by the first housing 210 and the second housing 220. For example, as illustrated in FIG. 2B, when the electronic device 200 is in the folded state (e.g., the completely folded state), the hinge cover 265 may be exposed to the outside between the first housing 210 and the second housing 220. When the first housing 210 and the second housing 220 are in the intermediate state in which the first housing 210 and the second housing 220 form a predetermined angle therebetween, the hinge cover 265 may be at least partially exposed to the outside between the first housing 210 and the second housing 220. In this case, the exposed area may be smaller than that in the completely folded state. According to an embodiment of the disclosure, the hinge cover 265 may include a curved surface.

Hereinafter, the operation of the first housing 210 and the second housing 220 and respective areas of the display 230 according to the operating states (e.g., the unfolded state (flat state) and the folded state) of the electronic device 200 will be described.

According to an embodiment of the disclosure, when the electronic device 200 is in the unfolded state (flat state) (e.g., the state in FIG. 2A), the first housing 210 and the second housing 220 may form an angle of 180 degrees therebetween, and the first area 231a and the second area 231b of the display may be disposed to be oriented in the same direction. In addition, the folding area 231c may form the same plane as the first area 231a and the second area 232b. According to another embodiment, when the electronic device 200 is in the unfolded state (flat state), when the first housing 210 and the second housing 220 are folded in the opposite direction such that the second surface 212 and the fourth surface 222 face each other, the first area 231a and the second area 231b of the display may be disposed to face away from each other.

When the electronic device 200 is in the folded state (e.g., the state of FIG. 2B), the first housing 210 and the second housing 220 may be disposed to face each other. The first area 231a and the second area 231b of the display 230 may face each other while forming a narrow angle (e.g., an angle between 0 and 10 degrees) relative to each other. At least a portion of the folding area 231c may be configured as a curved surface having a predetermined curvature.

When the electronic device 200 is in the intermediate state, the first housing 210 and the second housing 220 may be disposed to form a certain angle therebetween. The first area 231a and the second area 231b of the display 230 may form therebetween an angle greater than that in the folded state and smaller than that in the unfolded state. At least a portion of the folding area 231c may be configured as a curved surface having a predetermined curvature, and the curvature in this case may be smaller than that in the folded state.

FIG. 2C is an exploded perspective view of an electronic device 200 according to an embodiment of the disclosure.

Referring to FIG. 2C, the electronic device 200 may include a display 230, a support member assembly 260, at least one printed circuit board 270, a first housing 210, a second housing 220, a first rear surface cover 240, and a second rear surface cover 250. The display (display unit) 230 (e.g., the first display) may be referred to as a display module or a display assembly.

The display 230 may include a display panel 231 (e.g., a flexible display panel), and at least one plate 232 or layer on which the display panel 231 is seated. The one or more plates 232 may include a conductive plate (e.g., Cu sheet or SUS sheet) disposed between the display panel 231 and the support member assembly 260. The conductive plate may be configured to have substantially the same area as the display, and the area facing the folding area of the display may be configured to be bendable. The plate 232 may include at least one auxiliary material layer (e.g., a graphite member) disposed on the rear surface of the display panel 231. The plate 232 may have a shape corresponding to that of the display panel 231. For example, a partial area of the first plate 232 may have a shape corresponding to that of a notch area 233 in the display panel 231.

The support member assembly 260 may include a first support member 261 (e.g., the first support plate), a second support member 262 (e.g., the second support plate), a hinge 264 disposed between the first support member 261 and the second support member 262, a hinge cover 265 that covers the hinge 264 when the hinge 264 is viewed from the outside, and at least one wiring member 263 (e.g., a flexible printed circuit board (FPCB)) extending across the first support member 261 and the second support member 262.

The support member assembly 260 may be disposed between the plate 232 and the at least one printed circuit board 270. For example, the first support member 261 may be disposed between the first area 231a of the display 230 and a first printed circuit board 271. The second support member 262 may be disposed between the second area 231b of the display 230 and a second printed circuit board 272.

The wiring member 263 and the hinge structure 264 may be at least partially disposed inside the support member assembly 260. The wiring member 263 may be disposed in a direction across the first support member 261 and the second support member 262 (e.g., the x-axis direction). The wiring member 263 may be disposed in a direction (e.g., the x-axis direction) perpendicular to the folding axis (e.g., they axis or the folding axis A in FIG. 2A) of the folding area 231c.

As described above, the at least one printed circuit board 270 may include a first printed circuit board 271 disposed on the first support member 261 side and a second printed circuit board 272 disposed on the second support member 262 side. The first printed circuit board 271 and the second printed circuit board 272 may be disposed inside a space defined by the support member assembly 260, the first housing 210, the second housing 220, the first rear surface cover 240, and the second rear surface cover 250. Components for implementing various functions of the electronic device 200 may be disposed on the first printed circuit board 271 and the second printed circuit board 272.

In the first space of the first housing 210, the first printed circuit board 271 disposed in the space provided through the first support member 261, a first battery 291 disposed at a position facing a first swelling hole 2611 in the first support member 261, at least one sensor module 281, or at least one camera module 282 may be included. The first housing 210 may include a window glass 283 disposed to protect the at least one sensor module 281 and the at least one camera module 282 at a position corresponding to the notch area 233 in the display 230. In the second space of the second housing 220, the second printed circuit board 272 disposed in the second space provided through the second support member 262 and a second battery 292 disposed at a position facing a second swelling hole 2621 in the second support member 262 may be included. The first housing 210 and the first support member 261 may be configured integrally with each other. The second housing 220 and the second support member 262 may be configured integrally with each other. A sub-display 252 may be disposed in the second space of the second housing 220. The sub-display 252 (e.g., the second display) may be disposed to be visible from the outside through at least a partial area of the second rear surface cover 250.

The first housing 210 may include a first rotation support surface 214, and the second housing 220 may include a second rotation support surface 224, which corresponds to the first rotation support surface 214. The first rotational support surface 214 and the second rotation support surface 224 may respectively include curved surfaces corresponding to curved surfaces included in the hinge cover 265.

When the electronic device 200 is in the unfolded state (e.g., the state illustrated in FIG. 2A), the first rotation support surface 214 and the second rotation support surface 224 may cover the hinge cover 265 such that the hinge cover 265 is not exposed to the rear surface of the electronic device 200 or is minimally exposed to the rear surface of the electronic device 200. When the electronic device 200 is in the folded state (e.g., the state of FIG. 2B), the first rotation support surface 214 and the second rotation support surface 224 may rotate along the curved surfaces included in the hinger cover 265 such that the hinge cover 265 is exposed to the rear surface of the electronic device 200 as much as possible.

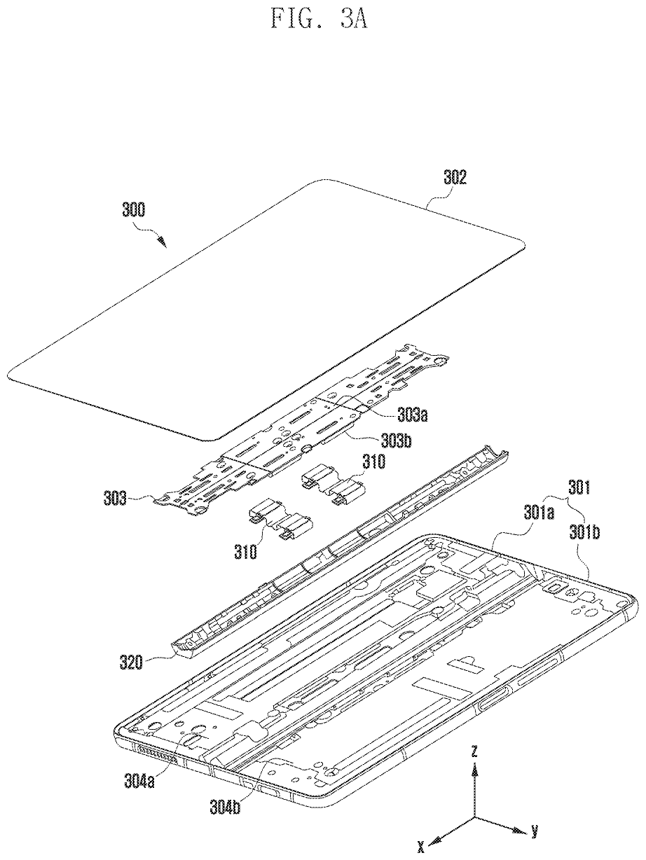

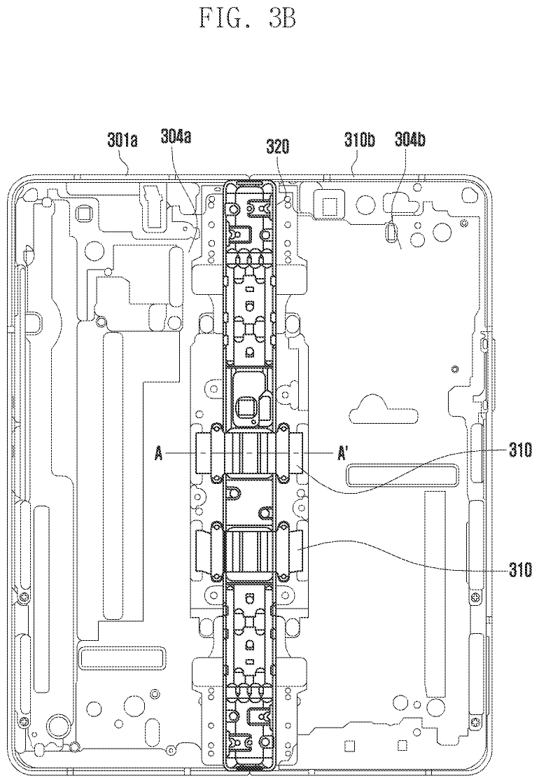

FIG. 3A is an exploded perspective view of the foldable electronic device 300 in the unfolded state according to an embodiment of the disclosure.

FIG. 3B is a front view of the foldable electronic device 300 in the unfolded state according to various embodiments of the disclosure.

FIG. 3C is a cross-sectional view of the foldable electronic device 300 in the unfolded state according to various embodiments of the disclosure.

Referring to FIG. 3B, illustration of the flexible display 302 of the foldable electronic device 300 is omitted for clarity.

Referring to FIGS. 3A and 3B, the foldable electronic device 300 (e.g., the electronic device 200 in FIGS. 2A to 2C) may include: a flexible display 302 (e.g., the display 230 in FIGS. 2A to 2C); a foldable enclosure 301 (e.g., a pair of housings 210 and 220 in FIGS. 2A to 2C); support members 304a and 304b (e.g., the first support member 261 and the second support member 262 in FIG. 2C), a hinge 303 (e.g., the hinge 264 in FIG. 2C), a hinge enclosure 320 (e.g., the hinge cover 265 in FIGS. 2A to 2C); and a flexible cable 310 (e.g., the wiring member 263 in FIG. 2C).

The foldable enclosure 301 may be folded and unfolded when the foldable electronic device 300 is folded and unfolded, and may have an opening in which the flexible display 302 is to be displayed. The opening may be opened facing upward (in the z-axis direction in FIG. 3A) in the unfolded state of the foldable electronic device 300. The foldable enclosure 301 may include a plurality of sub-enclosures 301a and 301b rotatably coupled to each other by a hinge 303 to be described later. At least one of various electrical components of the foldable electronic device 300 (e.g., the printed circuit boards 271 and 272 in FIG. 2C, the antenna module 197 in FIG. 1, the sensor module 281 in FIG. 2C, and/or the batteries 291 and 292 in FIG. 2C) may be disposed in each of the sub-enclosures 301a and 301b. Inside each of the sub-enclosures 301a and 301b, support members 304a or 304b for supporting electrical components (e.g., a printed circuit board, an antenna module, a sensor module, and/or a battery) disposed in each of the sub-enclosures 301a and 301b may be disposed, respectively.

The flexible display 302 may include a flexible display 302 panel and display support members 302a and 302b configured to support the flexible display 302 panel.

By rotatably coupling the plurality of sub-enclosures 301a and 301b relative to each other, the hinge 303 may enable the foldable enclosure 301 to be folded or unfolded about at least one rotation axis. The hinge 303 may be disposed such that the rotation axis is in a direction perpendicular to the upward direction (e.g., the z-axis direction of FIG. 3A), for example, the x-axis direction. The hinge 303 may include hinge brackets 303a and 303b. The hinge brackets 303a and 303b may be coupled to the display support members 302a and 302b to support the folding action of the display.

The hinge enclosure 320 may be a member that at least partially surrounds and protects the hinge 303. The hinge enclosure 320 may be, for example, a member that protects the hinge 303 from an external impact or foreign substances applied from a lower portion (e.g., in the −z direction). The hinge enclosure 320 may include an inner space 321 in which a flexible cable 310 to be described later is accommodated. A detailed configuration of the hinge enclosure 320 will be described later.

The flexible cable 310 may be a cable that interconnects different electrical components disposed in different sub-enclosures 301a and 301b. The flexible cable 310 may pass through a space between the lower portion (e.g., the −z-axis direction) of the hinge 303 and the upper portion (e.g., the z direction) of the hinge 303 housing, from one sub-enclosure 301a or 301b to another sub-enclosure 301a or 301b. A detailed configuration of the flexible cable 310 will be described later.

FIG. 4A is a perspective view illustrating a flexible cable 310 according to an embodiment of the disclosure.

FIG. 4B is a side view illustrating the flexible cable 310 according to an embodiment of the disclosure.

Referring to FIGS. 4A and 4B, the flexible cable 310 may include a cable body 311 and a plurality of cable connectors 312. The cable body 311 may be a flexible cable including at least one conductor line. For example, the flexible cable may include a ribbon cable, a flexible flat cable (FFC), or a printed flat cable (PFC) (which may include, for example, a flexible polymer thin plate and a conductor line formed on the polymer thin plate through etching or printing like a flexible printed circuit board (FPCB)). The cable connectors 312 may be members disposed at opposite terminal ends of the cable body 311 and coupled to a plurality of electrical components (e.g., a printed circuit board, an antenna module, a sensor module, and/or a battery), which are connected by the flexible cable 310. As for a method of coupling the cable connectors 312, known connector techniques such as an interference fit and/or a snap coupling may be referred to. In some embodiments, the flexible cable 310 may include fixing members 313 for coupling the cable body 311 to the support members 304a and 304b.

The flexible cable 310 may be bent in various ways to be located inside the foldable electronic device 300. In addition, a partial area of the flexible cable 310 may include a formed portion 311a, which is plastically formed in a bent state. The bending of the flexible cable 310 will be described later.

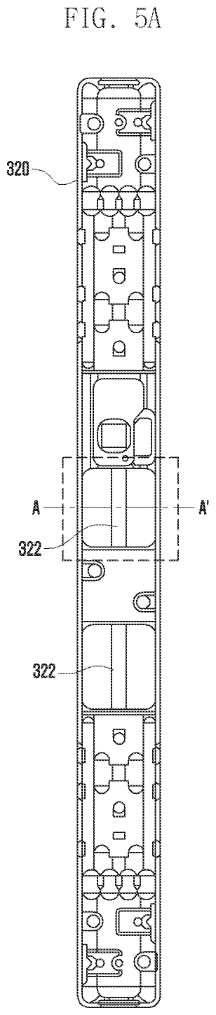

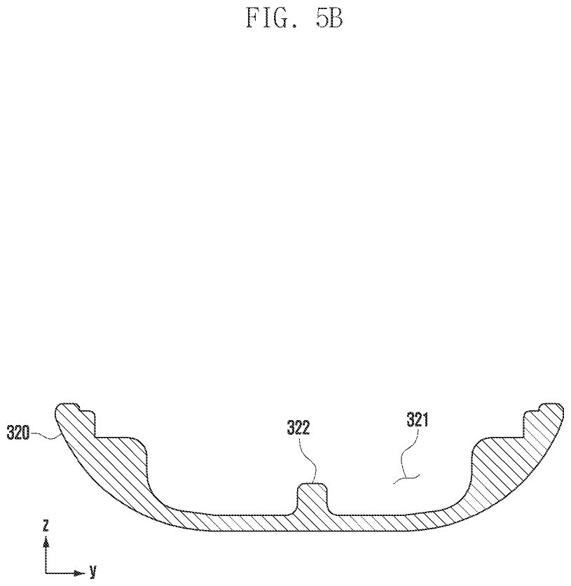

FIG. 5A is a plan view illustrating a hinge enclosure 320 of a foldable electronic device 300 according to an embodiment of the disclosure.

FIG. 5B is a cross-sectional view illustrating the hinge enclosure 320 of the foldable electronic device 300 according to an embodiment of the disclosure.

The cross-section of FIG. 5B is a cross-section taken in the direction A-A′ of FIG. 5A.

Referring to FIGS. 5A and 5B, the hinge enclosure 320 may be configured to surround a hinge 303 from at least a lower direction (the −z direction). An inner space 321 may be provided in at least one area of the hinge enclosure 320. In some embodiments, the inner space 321 may be provided in an area of the hinge enclosure 320 through which the flexible cable 310 passes.

The hinge enclosure 320 may include a protrusion 322 provided on the inner surface of the inner space 321. The protrusion 322 may protrude upward (in the z-axis direction) from the central portion of the inner space 321 as a reference when viewed from a side (in the x-axis direction). In some embodiments, the protrusion 322 may protrude and extend in a vertical direction on the inner surface of the inner space 321.

The thickness t of an area of the hinge enclosure 320 in which the inner space 321 is provided may be thinner than other areas. As the thickness of a partial area of the hinge enclosure 320 decreases, the risk that the hinge enclosure 320 is deformed by an external impact or stress increases. The protrusion 322 may reinforce the hinge 303 in the inner space 321. For example, as the protrusion 322 protrudes and extends perpendicularly to the inner surface of the inner space 321 so that the protrusion 322 may act as a crossbeam for the inner surface of the inner space 321. By extending in the direction of the rotation axis (the x-axis direction) of the hinge 303 in the inner space 321, the protrusion 322 may reinforce the hinge enclosure 320 more effectively.

In addition, the protrusion 322 may reduce damage to the flexible cable 310 by controlling the bending of the flexible cable 310 in the inner space 321 of the hinge enclosure 320. This will be described later.

Referring back to FIG. 5B, a buffer member and/or a lubricating layer may be disposed on the surface of the protrusion 322.

The buffer member may be a member that relieves, on the surface of the protrusion 322, an impact and stress generated in the flexible cable 310 by collision or rubbing between the flexible cable 310 and the protrusion 322. The buffer member may include an elastic material such as nitrile rubber, butyl rubber, polybutadiene, and/or thermoplastic polyurethane (TPU). In some embodiments, the buffer member may include foam formed of the aforementioned elastic material.

The lubricating layer may be a member to reduce, on the surface of the protrusion 322, frictional damage caused to the flexible cable 310 by rubbing between the flexible cable 310 and the protrusion 322. The lubricating layer may include a lubricating material. The lubricating material may include, for example, a solid inorganic lubricant, such as graphite, talc, molybdenum disulfide, and/or hexagonal boron nitride, a polymer lubricant, such as polypropylene or polytetrafluoroethylene (PTFE), or an emulsion lubricant, such as lubricating oil or grease. In some embodiments, the lubricating layer may be formed on the surface of the buffer member disposed on the surface of the protrusion 322.

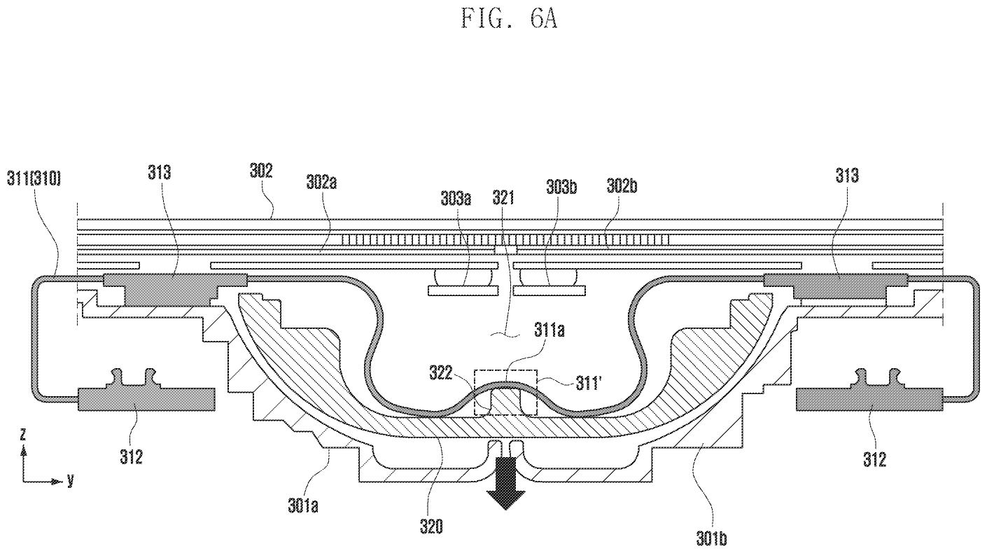

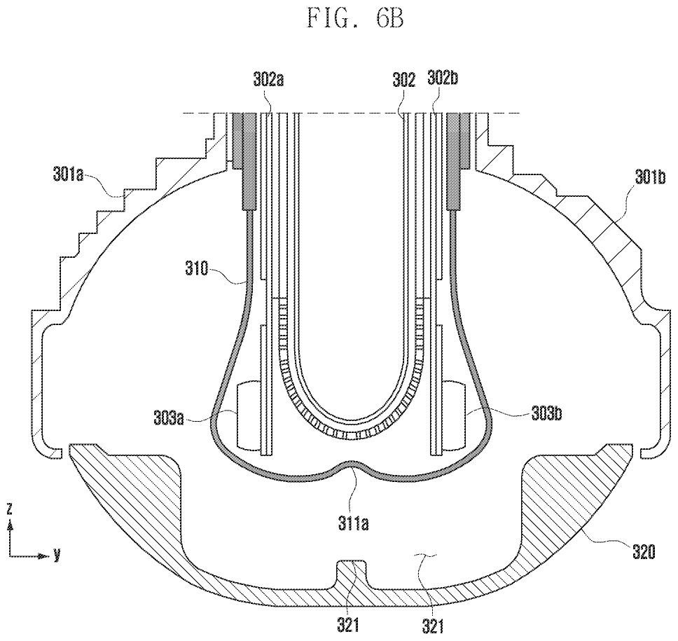

FIG. 6A is a cross-sectional view of a hinge portion of a foldable electronic device in the unfolded state according to an embodiment of the disclosure.

FIG. 6B is a cross-sectional view of the hinge portion of the foldable electronic device in the folded state according to an embodiment of the disclosure.

The cross-section of FIG. 6A is a cross-section taken in the direction A-A′ of FIG. 3B. In FIGS. 6A and 6B, illustration of the foldable enclosure 301 and the printed circuit board of the foldable electronic device 300 is omitted for clarity.

Referring to FIGS. 6A and 6B, in the folded state of the foldable electronic device 300, the flexible cable 310 of the foldable electronic device 300 may pass through the space between the lower portion of the hinge 303 and the upper portion of the hinge enclosure 320 along an area in which the flexible display 302 is folded and the outside of the hinge brackets 303a and 303b. Referring to FIG. 4B, in the unfolded state of the foldable electronic device 300, the flexible cable 310 may be accommodated in the inner space 321 of the hinge enclosure 320 by being bent downward (e.g., in the −z direction). In the unfolded state of the foldable electronic device 300, the central portion A of the area of the flexible cable 310 passing through the space between the hinge 303 and the hinge enclosure 320 may be further bent to protrude upward (e.g., in the z-direction). By bending the flexible cable 310 as described above, the length of the flexible cable 310 that can be accommodated in the spatial limitation of the inner space 321 of the hinge enclosure 320 may be increased. The effects obtained from this will be described later.

When the foldable electronic device 300 is in the unfolded state, the flexible cable 310 may be bent in substantially the same direction as the direction in which the protrusion 322 protrudes (e.g., upward, that is, in the z direction) in an area 311′ corresponding to the area in which the protrusion 322 of the hinge enclosure 320 is provided. The bending of the above-described flexible cable 310 may occur due to the presence of the protrusion 322. By being brought into contact with the protrusion 322, the flexible cable 310 may be bent in the direction in which the protrusion 322 protrudes. In another scenario, by being formed, the flexible cable 310 may be bent in a direction substantially the same as the direction in which the protrusion 322 protrudes. The formed portion 311a of the flexible cable 310 may be engaged with the protrusion 322 in the unfolded state of the foldable electronic device 300. For example, the protrusion 322 and the formed portion 311a may be mated with each other.

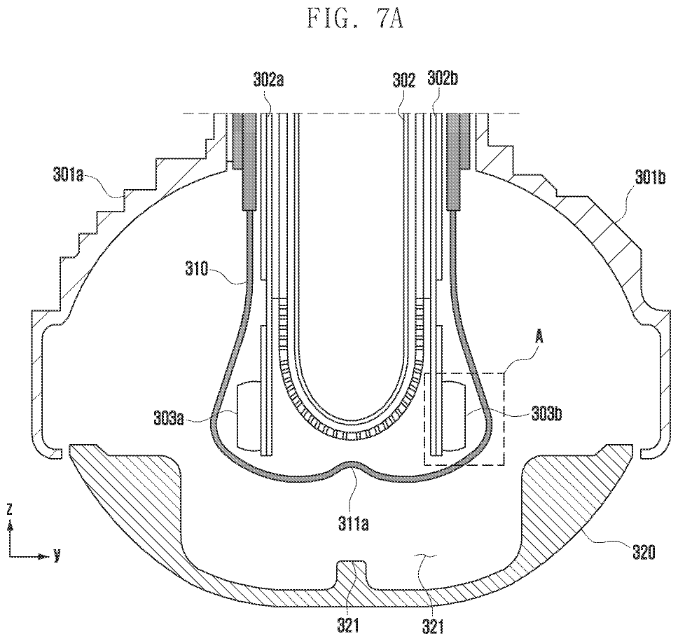

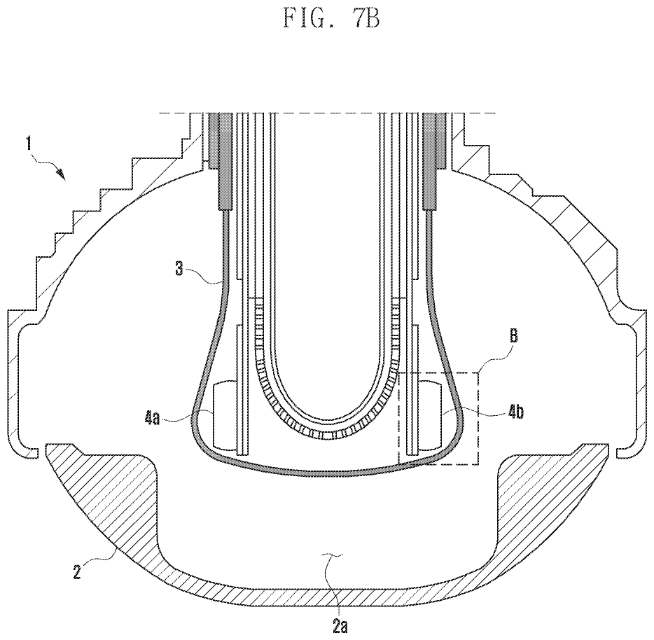

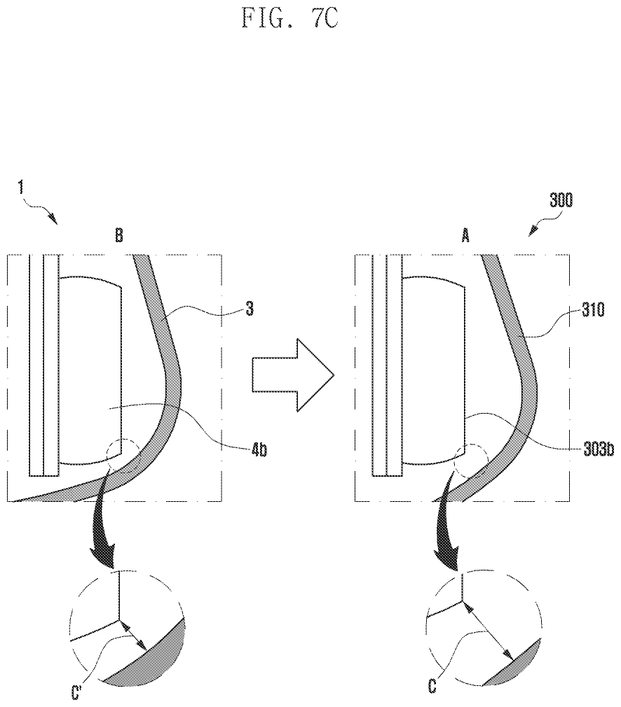

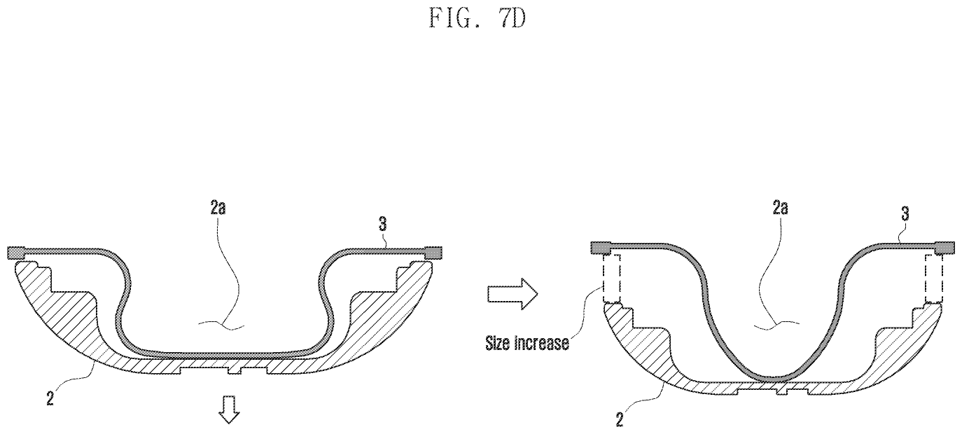

FIG. 7A is a cross-sectional view of a hinge portion of a foldable electronic device in the folded state according to an embodiment of the disclosure.

FIG. 7B is a cross-sectional view of a hinge portion of a foldable electronic device 1 according to an embodiment of the disclosure.

FIG. 7C illustrates enlarged cross-sectional views of hinge portions of the foldable electronic device 300 and the foldable electronic device of the comparative example according to an embodiment of the disclosure.

FIG. 7D is a schematic view illustrating a hinge enclosure 320 and a flexible cable 310 of the foldable electronic device 1 of the comparative example according to an embodiment of the disclosure.

FIG. 7C illustrates enlarged views of portions A and B of FIGS. 7A and 7B.

Referring to FIGS. 7A and 7B, in the foldable electronic device 1 of the comparative example, there is no protrusion inside the hinge enclosure 2, and the formed portion is not provided in the flexible cable 3. Therefore, it can be seen that the flexible cable 310 of the disclosure has a longer length than the flexible cable 3 of the comparative example.

Referring to FIG. 7C, it can be seen that, as the length of the flexible cable 310 increases, the gap C between components disposed on the periphery of the hinge 303 of the foldable electronic device 300 such as the display support members 302a and 302b and/or the hinge brackets 303a and 303b and the flexible cable 310 increases. Since the foldable electronic device 1 of the comparative example has an insufficient gap C′, due to the repeated interference and rubbing between the flexible cable 3 and the hinge brackets 4a and 4b at the time of folding the foldable electronic device 1, the flexible cable 3 may be damaged. Since the flexible cable 310 of the disclosure has a sufficient gap in the folded state, it is possible to reduce the risk of damage to the flexible cable 310 due to interference and rubbing.

In addition, in the case of increasing the length of the flexible cable 3 to increase the gap C′ in the foldable electronic device 1 of the comparative example, it may be difficult to accommodate the flexible cable 3 in the limited inner space 2a of the hinge closure 2 while the foldable electronic device 1 of the comparative example is unfolded. Therefore, as the flexible cable 3 is bent with an excessively small radius of curvature, for example, by being folded or crumpled within the inner space 2a of the hinge enclosure 2 of the comparative example, the risk of damage to the flexible cable 3 increases.

Referring to FIG. 7D, in order to address the above-described risk in the foldable electronic device 1 of the comparative example, it is necessary to increase the size of the hinge enclosure 2, which may inhibit the downsizing of the foldable electronic device 1 of the comparative example. According to an embodiment of the disclosure, as the flexible cable 310 is bent by the formed portion 311a and/or the protrusion 322 in the inner space 321, the length of the flexible cable 310 that can be accommodated inside the hinge enclosure 320 is increased. Thus, it is possible to reduce the above-mentioned problems.

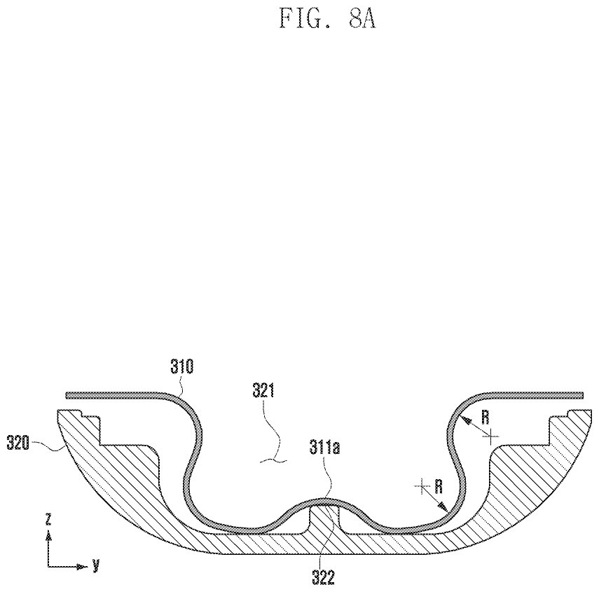

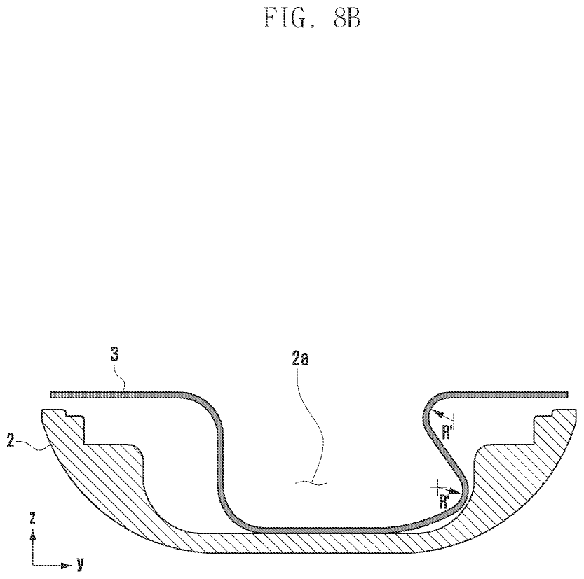

FIG. 8A is a schematic diagram illustrating a hinge enclosure and a flexible cable of the foldable electronic device 300 according to an embodiment of the disclosure.

FIG. 8B is a schematic view illustrating a hinge enclosure and a flexible cable of a foldable electronic device 1 of a comparative example according to an embodiment of the disclosure.

Referring to FIGS. 8A and 8B, the protrusion 322 of the foldable electronic device 300 according to an embodiment of the disclosure may restrict the unbalanced movement of the flexible cable 310 in the inner space 321 of the hinge enclosure 320 since the formed portion 311a of the flexible cable 310 is engaged with the protrusion 322. For example, since the formed portion 311a is mated with the protrusion 322, the unbalanced movement of the flexible cable 310 about the protrusion 322 may be reduced.

Referring to FIG. 8B, in the unfolded state of the foldable electronic device 1 of the comparative example not including the protrusion, the flexible cable 3 may be bent in the inner space 2a of the hinge enclosure 2 in an unbalanced manner or moved. As a result, the flexible cable 3 may be located in the inner space 2a in an unbalanced manner. Because the flexible cable 3 is located in the inner space 2a in an unbalanced manner, some areas of the flexible cable 3 may be bent with an excessively small radius of curvature R′. As the radius of curvature R′ decreases, the risk that the conductor of the flexible cable 3 is damaged increases by tensile force or fatigue. Referring back to FIG. 8A, since the protrusion 322 of the disclosure restricts the flexible cable 310 from moving in an unbalanced manner, it is possible to restrict the flexible cable 310 from being bent with an excessively small radius of curvature R.

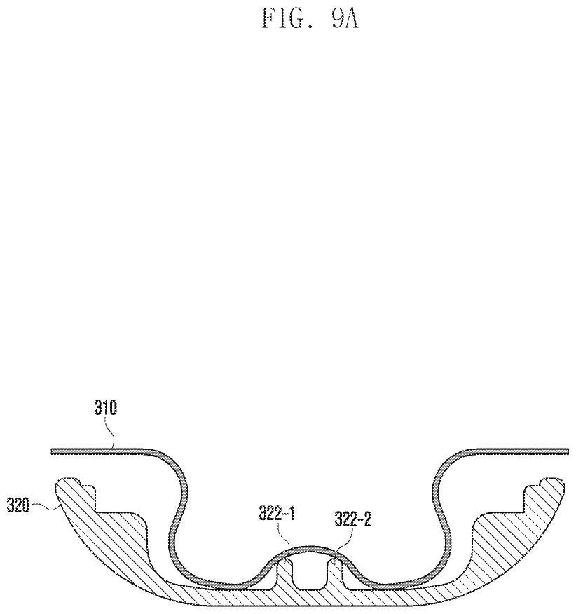

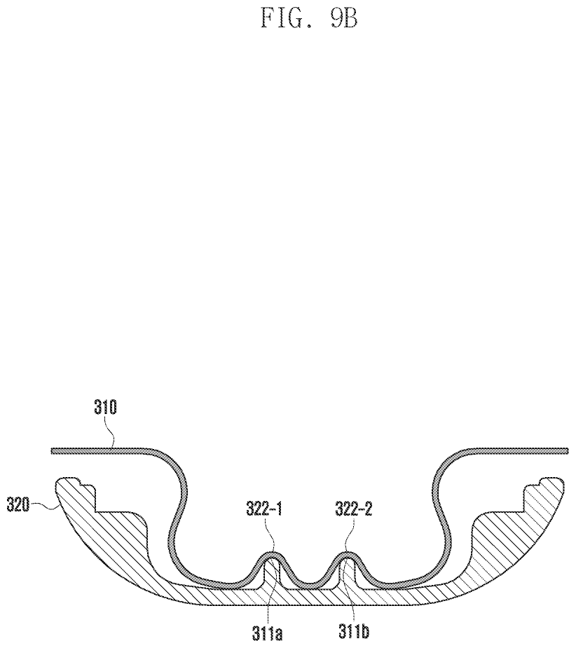

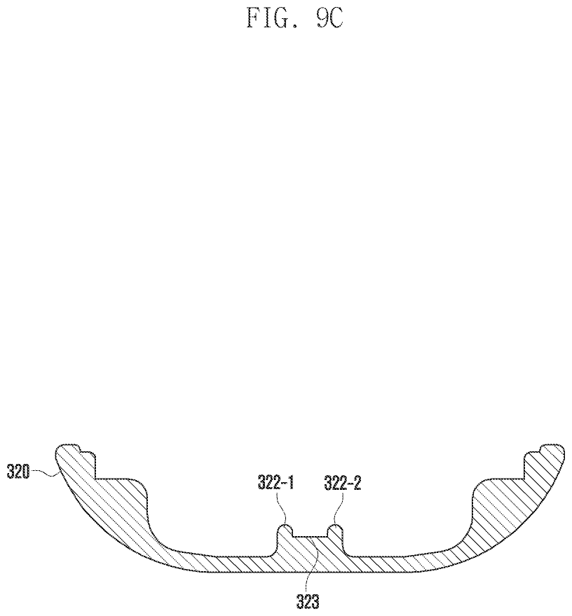

FIG. 9A is a schematic view illustrating a hinge enclosure and a flexible cable of according to an embodiment of the disclosure.

FIG. 9B is a schematic view illustrating a hinge enclosure and a flexible cable of according to an embodiment of the disclosure.

FIG. 9C is a schematic view illustrating a hinge enclosure according to an embodiment of the disclosure.

Referring to FIGS. 9A and 9B, according to another embodiment of the disclosure, the hinge enclosure 320 may include a plurality of protrusions 322-1 and 322-2 provided on the inner surface of the inner space 321. For example, two protrusions 322-1 and 322-2 may be provided on the inner surface of the hinge enclosure 320. A plurality of protrusions 322 may additionally reinforce the hinge enclosure 320. Referring to FIG. 9A, the plurality of protrusions 322-1 and 322-2 may be provided adjacent to each other in one area of the inner space 321 of the hinge enclosure 320. The flexible cable 310 may be bent in a direction in which the protrusions 322 protrude in the area of the inner space 321 in which the plurality of protrusions 322-1 and 322-2 are provided. Since the plurality of protrusions 322-1 and 322-2 occupy a larger area on the inner surface of the inner space 321 than a single protrusion (e.g., the protrusion 322 in FIG. 5B), the radius R2 at which the flexible cable 310 is bent may be increased. Due to the increase in radius, stress and fatigue received when the flexible cable 310 is bent may be reduced.

Referring to FIG. 9B, according to another embodiment of the disclosure, the plurality of protrusions 322-1 and 322-2 may be disposed to be spaced apart from each other, and the flexible cable 310 may be formed in a plurality of areas 311a and 311b to be bent in a direction in which the protrusions 322-1 and 322-2 protrude in a plurality of areas corresponding to the plurality of protrusions 322-1 and 322-2. By plastically forming the flexible cable 310 a plurality of times corresponding to the plurality of protrusions 322, the length of the flexible cable 310 that can be accommodated may be further increased.

Referring to FIG. 9C, the hinge enclosure 320 may include a reinforcing member 323 located between the plurality of protrusions 322-1 and 322-2 and interconnecting the plurality of protrusions 322-1 and 322-2. The reinforcing member 323 may further reinforce the hinge enclosure 320.

A foldable electronic device 300 according to an embodiments of the disclosure may include: a foldable enclosure 301 including a plurality of sub-enclosures 301a and 301b in each of which at least one electrical component is located, wherein the foldable enclosure 301 is configured to be folded and unfolded and has an opening opened in a first direction in the unfolded state; a hinge 303 configured to couple the plurality of sub-enclosures 301a and 301b to be rotatable around at least one rotational axis; a hinge enclosure 320 configured to cover the hinge 303 from at least a second direction opposite to the first direction and including an inner space 321; a protrusion 322 protruding on an inner surface of the inner space 321 of the hinge enclosure 320; and a flexible cable 310 configured to interconnect a plurality of electrical components disposed in the plurality of sub-enclosures 301a and 301b while passing through a space between the hinge 303 and the hinge enclosure 320, wherein, when the foldable enclosure 301 is unfolded, the flexible cable 310 is bent in an area corresponding to the protrusion 322 to protrude in a direction in which the protrusion 322 protrudes.

The flexible cable 310 may be plastically formed such that the area corresponding to the protrusion 322 protrudes in the direction in which the protrusion 322 protrudes. The protrusion 322 may restrict the flexible cable 310 from being bent asymmetrically around the protrusion 322 by being engaged with the plastically formed area of the flexible cable 310.

The inner space 321 may be provided in an area through which the flexible cable 310 passes. In some embodiments, the protrusion 322 may be located on a center line of the inner space 321 of the hinge enclosure 320 when viewed in the first direction.

The protrusion 322 may extend in the inner space 321 in the direction of the rotation axis of the hinge 303. The protrusion 322 may protrude in a direction perpendicular to the inner surface of the inner space 321. The protrusion 322 may reinforce the hinge enclosure 320 by extending in the direction perpendicular to the inner surface of the inner space 321.

The hinge enclosure 320 may include a plurality of protrusions 322 protruding on the inner surface of the inner space 321. The flexible cable 310 may be plastically formed such that a plurality of areas corresponding to the plurality of protrusions 322 are bent in a direction in which the protrusions 322 protrude. The plurality of protrusions 322 may be located adjacent to each other in one area on the inner surface of the inner space 321, and the flexible cable 310 may be plastically formed such that the flexible cable is bent in an area corresponding to an area in which the plurality of protrusions 322 located adjacent to each other are plastically formed in the direction in which the protrusions 322 protrude. The hinge enclosure 320 may include a reinforcing member 323 located between the plurality of protrusions 322 on the inner surface of the inner space 321 and connecting the plurality of protrusions 322 to each other.

The electronic device may further include a buffer member disposed on the surface of each of the protrusions 322. In some embodiments, the electronic device may further include a lubricating layer disposed on the surface of each of the protrusions 322.

A flexible cable 310 of a foldable electronic device 300 according an embodiment of the disclosure may include: a plurality of electrical components; a foldable enclosure 301 including a plurality of sub-enclosures 301a and 301b in each of which at least one of the plurality of electrical components is disposed, wherein the foldable enclosure 301 is configured to be folded and unfolded and has an opening opened in a first direction in the unfolded state; a hinge 303 configured to couple the plurality of sub-enclosures 301a and 301b to be rotatable around at least one rotational axis; a hinge enclosure 320 configured to cover the hinge 303 from at least a second direction opposite to the first direction and including an inner space 321; and a flexible cable 310, wherein the flexible cable 310 may be configured to interconnect the plurality of electrical components disposed in the plurality of sub-enclosures 301a and 301b while passing through a space between the hinge 303 and the hinge enclosure 320, and when the foldable enclosure 301 is unfolded, the flexible cable 310 may be bent in an area corresponding to the protrusion 322 to protrude in the first direction.

The flexible cable 310 may be plastically formed such that the area corresponding to the protrusion 322 protrudes in the direction in which the protrusion 322 protrudes.

A hinge enclosure 320 of a foldable electronic device 300 according to an embodiment of the disclosure may include: a plurality of electrical components; a foldable enclosure 301 including a plurality of sub-enclosures 301a and 301b in each of which at least one of the plurality of electrical component is disposed, wherein the foldable enclosure 301 is configured to be folded and unfolded and has an opening opened in a first direction in the unfolded state; a hinge 303 configured to couple the plurality of sub-enclosures 301a and 301b to be rotatable around at least one rotational axis; a hinge enclosure 320 configured to at least partially cover the hinge 303; and a flexible cable 310 configured to electrically interconnect at least two of the plurality of electrical components disposed in the plurality of sub-enclosures 301a and 301b while passing through the hinge enclosure 320, wherein the hinge enclosure 320 may include a protrusion 322 protruding on an inner surface of an inner space 321 thereof. In some embodiments, the flexible cable 310 is plastically formed such that an area corresponding to the protrusion 322 is bent in a direction in which the protrusion 322 protrudes, and the protrusion 322 may restrict the flexible cable 310 from being bent asymmetrically around the protrusion 322 by being engaged with the plastically formed area of the flexible cable 310. In some embodiments, the foldable electronic device may include a plurality of protrusions 322-1 and 322-2 protruding on the inner surface of the inner space 321 thereof.

A foldable electronic device 300 according to an embodiment of the disclosure may include: a foldable enclosure 301 including a plurality of sub-enclosures 301a and 301b in each of which at least one electrical component is located, wherein the foldable enclosure 301 is configured to be folded and unfolded and has an opening opened in a first direction in the unfolded state; a hinge 303 configured to couple the plurality of sub-enclosures 301a and 301b to be rotatable around at least one rotational axis; a hinge enclosure 320 located between a plurality of sub-enclosures 301a and 301b and configured to cover the hinge 303 from at least a second direction opposite to the first direction, wherein the hinge enclosure 320 includes an inner space 321; and a flexible cable 310 configured to interconnect a plurality of electrical components disposed in the plurality of sub-enclosures 301a and 301b while passing through a space between the hinge 303 and the hinge enclosure 320, wherein, when the foldable enclosure 301 is unfolded, the flexible cable 310 is bent in an area corresponding to the protrusion 322 to protrude in the first direction.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A foldable electronic device comprising a plurality of electrical components, the foldable electronic device comprising:
a foldable enclosure comprising a plurality of sub-enclosures in each of which at least one electrical component is located, wherein the foldable enclosure is configured to be folded and unfolded and has an opening opened in a first direction in an unfolded state;
a hinge configured to couple the plurality of sub-enclosures to be rotatable around at least one rotational axis;
a hinge enclosure configured to cover the hinge from at least a second direction opposite to the first direction and comprising an inner space;
a protrusion protruding on an inner surface of the inner space of the hinge enclosure; and
a flexible cable configured to interconnect a plurality of electrical components disposed in the plurality of sub-enclosures while passing through a space between the hinge and the hinge enclosure,
wherein, in case that the foldable enclosure is unfolded, the flexible cable is bent in an area corresponding to the protrusion to protrude in a direction in which the protrusion protrudes.

2. The foldable electronic device of claim 1, wherein the flexible cable is plastically formed such that the area corresponding to the protrusion protrudes in the direction in which the protrusion protrudes.

3. The foldable electronic device of claim 2, wherein the protrusion restricts the flexible cable from being bent asymmetrically around the protrusion by being engaged with the plastically formed area of the flexible cable.

4. The foldable electronic device of claim 1, wherein the inner space is provided in an area through which the flexible cable passes.

5. The foldable electronic device of claim 1, wherein the protrusion is located on a center line of the inner space of the hinge enclosure when viewed in the first direction.

6. The foldable electronic device of claim 1, wherein the protrusion extends in the inner space in a direction of the rotation axis of the hinge.

7. The foldable electronic device of claim 1, wherein the protrusion protrudes in a direction perpendicular to the inner surface of the inner space.

8. The foldable electronic device of claim 7, wherein the protrusion reinforces the hinge enclosure by extending in the direction perpendicular to the inner surface of the inner space.

9. The foldable electronic device of claim 1, wherein the hinge enclosure comprises a plurality of protrusions protruding on the inner surface of the inner space.

10. The foldable electronic device of claim 9, wherein the flexible cable is plastically formed such that a plurality of areas corresponding to the plurality of protrusions are bent in a direction in which the protrusions protrude.

11. The foldable electronic device of claim 9,
wherein the plurality of protrusions are located adjacent to each other in one area on the inner surface of the inner space, and
wherein the flexible cable is plastically formed such that the flexible cable is bent in an area corresponding to an area in which the plurality of protrusions located adjacent to each other are plastically formed in the direction in which the protrusions protrude.

12. The foldable electronic device of claim 9, wherein the hinge enclosure comprises a reinforcing member located between the plurality of protrusions on the inner surface of the inner space and connecting the plurality of protrusions to each other.

13. The foldable electronic device of claim 1, further comprising:
a buffer member disposed on a surface of each of the protrusions.

14. The foldable electronic device of claim 1, further comprising:
a lubricating layer disposed on a surface of each of the protrusions.

15. A flexible cable for a foldable electronic device, the flexible cable comprising:
a plurality of electrical components;
a foldable enclosure comprising a plurality of sub-enclosures in each of which at least one of the plurality of electrical components is disposed, wherein the foldable enclosure is configured to be folded and unfolded and has an opening opened in a first direction in an unfolded state;
a hinge configured to couple the plurality of sub-enclosures to be rotatable around at least one rotational axis; and
a hinge enclosure configured to cover the hinge from at least a second direction opposite to the first direction and comprising an inner space; and the flexible cable,
wherein the flexible cable is configured to interconnect the plurality of electrical components disposed in the plurality of sub-enclosures while passing through a space between the hinge and the hinge enclosure, and
wherein, when the foldable enclosure is unfolded, the flexible cable is bent in an area corresponding to a protrusion to protrude in the first direction.

16. The flexible cable of claim 15, wherein the flexible cable is plastically formed such that the area corresponding to the protrusion protrudes in the direction in which the protrusion protrudes.

17. A hinge enclosure for a foldable electronic device comprising:
a plurality of electrical components;
a foldable enclosure comprising a plurality of sub-enclosures in each of which at least one of the plurality of electrical component is disposed, wherein the foldable enclosure is configured to be folded and unfolded and has an opening opened in a first direction in an unfolded state;
a hinge configured to couple the plurality of sub-enclosures to be rotatable around at least one rotational axis; a hinge enclosure configured to at least partially cover the hinge; and
a flexible cable configured to electrically interconnect at least two of the plurality of electrical components disposed in the plurality of sub-enclosures while passing through the hinge enclosure,
wherein the hinge enclosure comprises a protrusion protruding on an inner surface of an inner space thereof.

18. The hinge enclosure of claim 17,
wherein the flexible cable is plastically formed such that an area corresponding to the protrusion is bent in a direction in which the protrusion protrudes, and
wherein the protrusion restricts the flexible cable from being bent asymmetrically around the protrusion by being engaged with the plastically formed area of the flexible cable.

19. The hinge enclosure of claim 17, further comprising a plurality of protrusions protruding on the inner surface of the inner space thereof.

20. A foldable electronic device comprising:
a foldable enclosure comprising a plurality of sub-enclosures in each of which at least one electrical component is located, wherein the foldable enclosure is configured to be folded and unfolded and has an opening opened in a first direction in an unfolded state;
a hinge configured to couple the plurality of sub-enclosures to be rotatable around at least one rotational axis;
a hinge enclosure configured to cover the hinge from at least a second direction opposite to the first direction and comprising an inner space; and
a flexible cable configured to interconnect a plurality of electrical components disposed in the plurality of sub-enclosures while passing through a space between the hinge and the hinge enclosure,
wherein, in case that the foldable enclosure is unfolded, the flexible cable is bent in an area corresponding to a protrusion to protrude in the first direction.
